(19) United States
(12) Patent Application Publication
(10) Pub. No.: US 2002/0122243 A1
(43) Pub. Date: Sep. 5, 2002

(54) Distributed gain optical fiber amplifier

(75) Inventor: Mustafa A.G. Abushagur, Huntsville, AL (US)

Correspondence Address: Mustafa A.G. Abushagur, 2203 Rhett Butler Lane, Huntsville, AL, 35803, US

(73) Assignee: Mustafa A.G. Abushagur, Huntsville, AL

(21) Appl. No.: 10/023,079

(22) Filed: Dec. 18, 2001

Related U.S. Application Data
(60) Provisional application No. 60/256,748, filed on Dec. 21, 2000.

(51) Int. Cl. H01S 3/00

(52) U.S. Cl. 359/341.1

(57) ABSTRACT

A distributed gain optical fiber amplifier makes use of a single or a plurality of counter propagating pumping optical beams, and a plurality of short lengths of doped fibers that are distributed along an optical network. Pumping optical beams is introduced into the fiber by coupling single or a plurality of pumping laser sources that can be operating at the same wavelength using a wavelength division multiplexer coupler. As the pumping energy propagates through the short lengths of the doped fibers some portion of the pump energy is transferred into the signal, which is propagating along the same fiber, causing it to be amplified.

### BACKGROUND

1. Field of the Invention

This invention relates to the field of optical communication networks and, more particularly, to the amplification of optical signals.

2. Background of the Invention

Today's high speed telecommunication networks employ optical fibers as the medium for transmission. These networks can extend to thousands of kilometers and can have hundreds of nodes. The optical signal continues to lose its power as it traverses the optical fiber due to fiber attenuation, coupling, splicing and splitting. Optical amplifier are the means for compensating such power loss. Currently, optical fiber amplifiers are located at the major nodes and supply high gain. This is very suitable for long-haul network where the aim is to send signals as far as possible without amplifications. For the short-span networks as the case for metro or access networks these fiber amplifiers are not suitable because these networks need for low cost low gain amplifiers.

### SUMMARY OF THE INVENTION

In accordance with the current invention, a distributed gain optical fiber amplifier includes a counter propagating pumping optical beams coupled into the fiber from one or more pumping energy sources. The amplification is achieved by short segments of doped fibers that are distributed along the network span. As the optical signal propagates along the communication fiber of the network it loses some of its power due to mainly absorption. The optical signal as it passes through a segment of the doped fiber gets amplified because of the transfer of energy from the pump energy to the optical signal. The pump sources emit light in the same wavelength range. The pump energy is coupled into the optical fiber by means of a wavelength division multiplexer (WDM) coupler or circulator. The said pump energy as it passes through the doped fiber is partially absorbed in the amplification process and the rest propagates along the communication fiber. The distributed gain optical fiber amplifier provides a compensation for the optical signal power that is absorbed and attenuated at the node drops along the fiber network. This in-turn provides power balancing along the network such that the optical signal power at the nodes will be about the same instead of being continuously reduced as it propagates along the network.

In an embodiment of the invention the network topology being in a form of a ring, the pump energies propagate in counter directions. The optical signal can be propagating either clockwise or counter clockwise around the ring. The counter propagating pump energy supplies the segments of the doped fiber amplifiers. The said pump energy of each of the counter propagating beams can be selected to be sufficient to supply at least half of the doped fiber segments around the ring. Both counter propagating pump beams may supply some of the doped fiber segments that are situated close to half way around the ring.

In a second embodiment of the invention, the distributed amplifier may be used in a tree-branch network topology. In the said configuration the pump energy and optical signal are coupled into the communication fiber by the means of a WDM coupler (or other apparatus such as a circulator) and the doped fiber segments are located after the branching of the network. As the network branches the optical signal and pump energy, which are co-propagating along the fiber, will be split between the branches in turn be reduced. The doped fiber distributed amplifiers amplify the optical signals to restore the losses.

In a third embodiment of the invention, the distributed amplifier may be used in a bus network topology. In the said configuration the pump energy and optical signal are coupled into the communication fiber by the means of a WDM coupler (or other apparatus such as a circulator). Two counter propagating pump energies are used. The doped fiber segments are located along the bus network. As the network branches at the add/drop nodes the optical signal will be reduced. The doped fiber distributed amplifiers amplify the optical signals to restore the losses.

### BRIEF DESCRIPTION OF THE DRAWINGS

FIG. 1 is a schematic view of the prior art of erbium doped fiber amplifiers.

FIG. 2 is an embodiment of the invention with counter propagating pumping beams around a ring network with a plurality of segments of the doped fiber.

FIG. 3 is a second embodiment of the invention with distributed amplifier in a tree topology network.

FIG. 4 is a third embodiment with a distributed amplifier in a bus network with 2 counter propagating pump beams.

### DETAILED DESCRIPTION OF THE PREFERED EMBODIMENT(S)

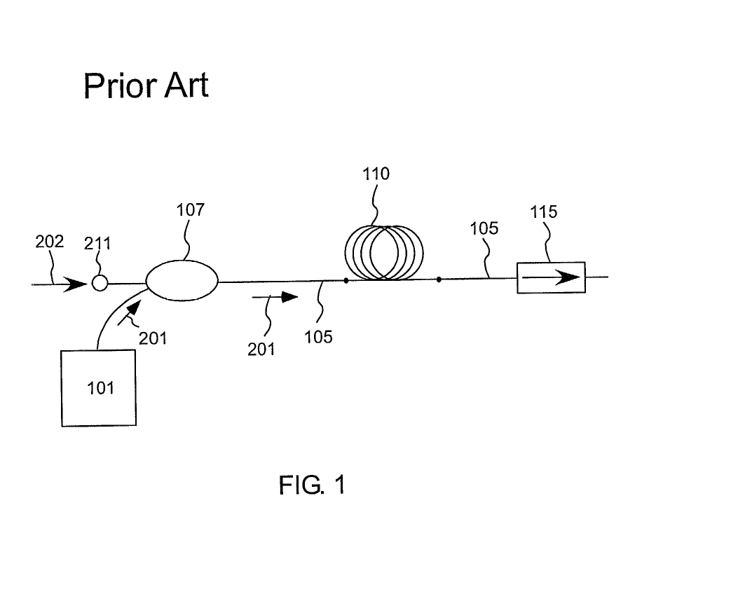

Shown in FIG. 1 is the prior art of erbium doped fiber amplifier (EDFA) in which an input signal 202 is directed into the amplifier input port 211. Pump energy 201 from a pump source 101 is coupled along with the input signal 202 by means of a wavelength division multiplexer coupler 107 into a communication fiber 105. Both optical signal and pump energy pass through a coil of erbium doped fiber 110 then back into communication fiber 105 and finally through isolator 115. Amplification takes place as a portion of the pump energy is absorbed in the erbium-doped fiber, which creates population inversion that is required for the stimulated emission process. During this process the optical input signal will be amplified by transferring portion of the absorbed energy into optical signal.

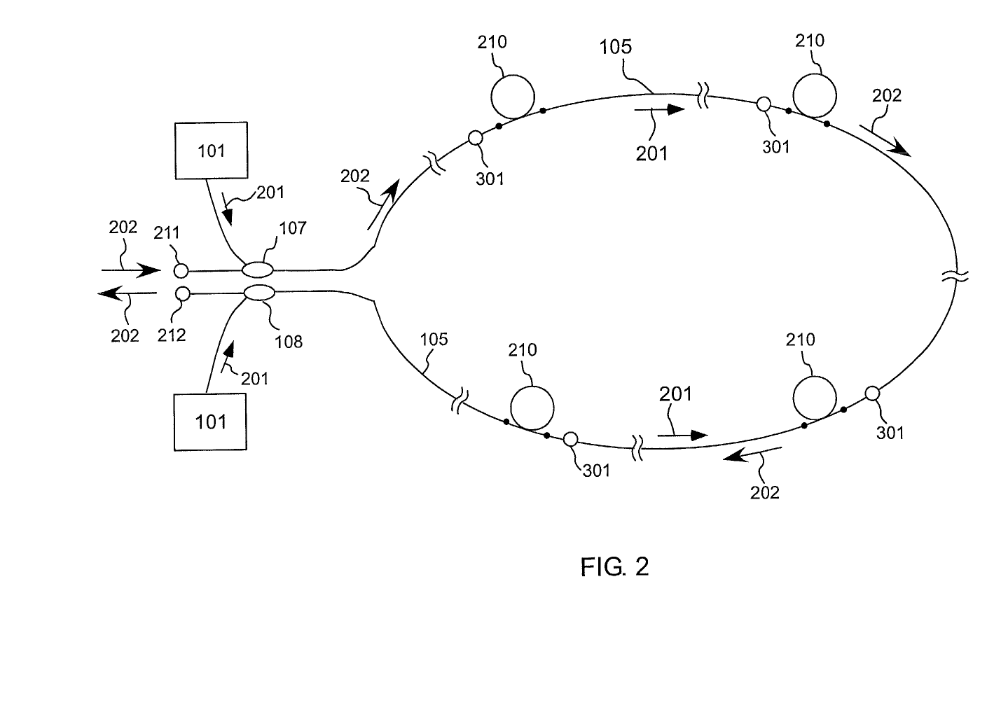

Shown in FIG. 2 is a distributed amplifier according to the present invention in which an input signal 202 is directed into the amplifier input port 211. The pump energy 201 from two pump sources 101 is coupled into the communication fiber 105 by means of WDM couplers 107 and 108. WDM coupler 107 couples both the pump energy and input optical signal into communication fiber, while WDM coupler 108 couples pump energy 201 into the fiber and direct the optical signal 202 towards the output port 212. Pump energies are counter propagating around the ring network. The optical signal and pump energy then propagate along the communication fiber 105. Optical add/drop nodes 301 are positioned around the said ring. Said add/drop nodes are located along the ring and can be many kilometers apart. Doped fiber segments 210 (referred to as gain-blocks) are located along the ring and may be many kilometers apart. Said doped fibers provide the amplification of the optical signal. Said doped fiber segments are short lengths of typically erbium-doped fibers that act as the active medium of the amplifier. The gain of these amplification blocks depends on the length and amount of pump power and doped fiber properties. The gain of said gain blocks are engineered to compensate for the optical signal loss caused by fiber attenuation and drops at the add/drop nodes. The counter propagating pump energy beams can be engineered in such a manner that each supplies half of the gain blocks around the ring or all gain blocks around the ring.

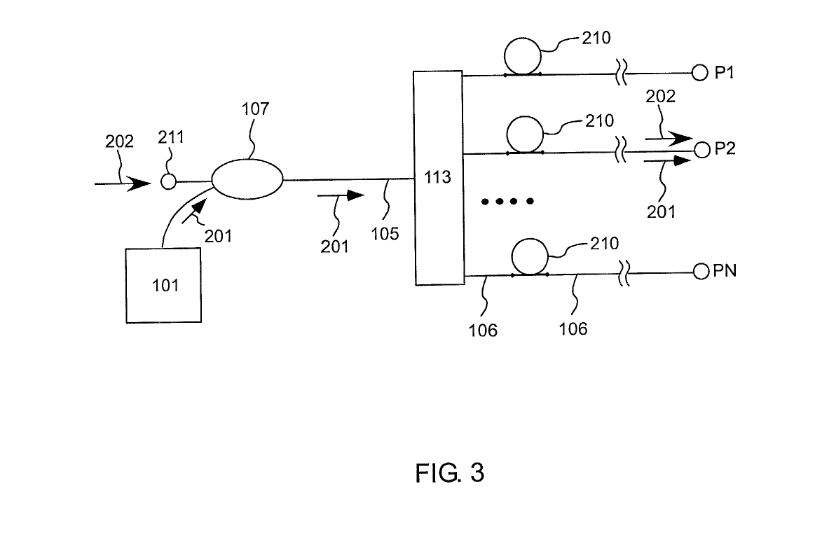

Shown in FIG. 3 is a second embodiment of the current invention in which an input signal 202 is directed into the amplifier input port 211. The pump energy 201 from pump source 101 is coupled into the communication fiber 105 by means of WDM coupler 107. WDM coupler 107 couples both the pump energy and input optical signal into communication fiber 105. The communication fiber is then connected to a 1×N splitter 113. The said splitter connects the input optical signal and pump energy from a single fiber into N fibers. For an ideal splitter the energy in each of the output fibers is 1/N of that in the input fiber. The plurality of output communication fibers 106 are then connected with short segments of doped fibers 210 which are then connected to communication fibers 106. Communications fibers 106 are terminated at nodes P1 to PN. The distance between the splitter and termination nodes can be many kilometers apart. After the splitter the optical signal may become too weak to produce satisfactory signal-to-noise ratio at the terminating nodes that can be many kilometers away. The distributed amplifier boosts the optical signal energy. The said amplification allows the increase in span of the optical links as well as the number of termination nodes of the network. The gain blocks can also be placed before the splitter to provide signal amplification.

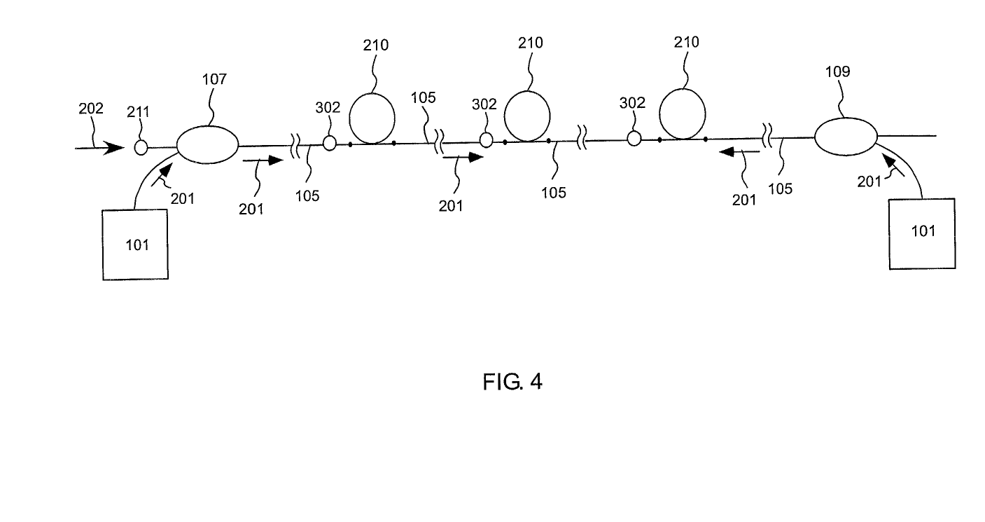

Shown in FIG. 4 is a third embodiment of the current invention in which an input signal 202 is directed into the amplifier input port 211. The pump energy 201 from two pump sources 101 are coupled into the communication fiber 105 by means of WDM couplers 107 and 109. The two pump sources operate at same wavelength range, e.g. 1480 nm for erbium-doped fiber. WDM coupler 107 couples both the pump energy and input optical signal into communication fiber 105. The optical communication fiber extends between the two WDM couplers except for the spliced short segments of the doped fiber gain blocks 210. A plurality of said doped fiber segments are distributed along the bus network. A plurality of add/drop nodes 302 are distributed along the network. Span between said nodes can be many kilometers apart. The power of the optical signal will be significantly decreased because of the fiber attenuation and signal drops at the add/drop nodes. The doped fiber segments using the pump power amplifies and restores the energy in the optical signal providing higher signal-to-noise ratio and longer network spans.

What is claimed is:

1. A distributed gain optical amplifier comprising:
a plurality of distributed short segments of doped fibers that act as the amplifying media when a pump energy passes through it along with the optical signal;
a single or a plurality of pump sources that are located at stationary locations in the network; and
a plurality of couplers and/or circulators to couple the pumping energies and optical signal into the fiber.

2. A distributed gain optical amplifier according to claim 1 wherein the pump energy from a single or a plurality of pump sources generating pump energy at the same wavelength range.

3. A distributed gain optical amplifier according to claim 1 wherein the pump energy is at all possible pumping wavelengths.

4. A distributed gain optical amplifier according to claim 1 wherein the gain block is made from doped optical fiber.

5. A distributed gain optical amplifier according to claim 1 wherein the pump energy and optical signals have different wavelengths.

6. A distributed gain optical amplifier according to claim 1 wherein the pump energy and optical signal propagate in the same fiber along the same direction or along opposite directions.

7. A distributed gain optical amplifier according to claim 1 wherein the optical signal and pump energy are coupled in the fiber by the means of a wavelength division multiplexer coupler.

8. A distributed gain optical amplifier according to claim 1 wherein the optical signal and pump energy are coupled in the fiber by the means of a circulator.

9. A distributed gain optical amplifier according to claim 1 that is used in a ring network for providing a loss-less ring network.

10. A distributed gain optical amplifier according to claim 1 that is used in a tree-branch network for providing optical signal energy compensation.

11. A distributed gain optical amplifier according to claim 1 that is used in a bus network for providing optical signal energy compensation.
